(19) United States
(12) Patent Application Publication
(10) Pub. No.: US 2007/0278271 A1
(43) Pub. Date: Dec. 6, 2007

(54) Walker support tote bag

(76) Inventor: Joe Koren, East Brunswick, NJ (US)

Correspondence Address: FURR LAW FIRM, 2622 DEBOLT ROAD, UTICA, OH, 43080, US

(21) Appl. No.: 11/306,261

(22) Filed: Dec. 21, 2005

(51) Int. Cl. B60R 9/00

(52) U.S. Cl. 224/407

(57) ABSTRACT

The current invention is a walker bag that is attached to a walker. The walker bag will attach to the walker with an attaching means like a hook and latch means such as Velcro. Zippers, snaps or buttons are not used so that the current invention is easier to use for those who may not have the dexterity to use those items. Different styles of bags will have different placements of Velcro each with very defined positions for the Velcro. These positions are over the top of the bar and along the side bars at the bottom of the bag. In the preferred embodiment there will be 6 pockets—3 on the face of the unit and 3 on the inside of the unit. These pockets will be elasticized so that they can easily enter the pocket without using zippers, buttons or snaps.

### BACKGROUND OF INVENTION

1. Field of Invention

The present invention relates to a walker support tote bag, and more particularly, to a tote bag which enables a user with limited dexterity to use.

2. Description of Prior Art

Walker supports are used to aid handicapped, injured and/or aged individuals to walk with stability and support. Such walker support devices typically have four spaced supporting legs which are attached to interconnecting handles or cross bars. This allows a person to grasp the handles to obtain support from the four spaced supporting legs. When using such walker supports, individuals must use both hands in lifting and moving the walker support a short distance forward, allowing the individual to make a step or two toward the walker support, so as to provide stabilized or balanced walking movements.

Although walker supports are needed to assist the walking of the handicapped, injured and/or aged individuals, they have not generally been provided with the added need/convenience for carrying various articles which the user may desire or require. For example, women users may not only want to carry their handbags containing personal belongings, but they also may desire to carry a liquid refreshment, personal grooming articles, etc., while at the same time using the walker support. While there have been some devices which have been developed to meet the convenience/need of users in this regard, they have generally fallen short of providing the desired uses/objectives of users.

3. Prior Art

While the prior art shows a variety of different bags containers and the like for use on baby strollers or shopping carts, very little consideration has been given to the development of a walker tote bag to meet the specific needs/conveniences of handicapped, injured or aged individuals.

U.S. Pat. No. 6,634,531 by Conte and issued on Oct. 21, 2003, is for pockets for attachment to ambulatory aids, strollers, backpacks and child carriers. It discloses a pocket system that provides easy attachment to a variety of support surfaces, such as crutches, walkers, backpacks, etc. The system has at least one pocket having an open end to receive articles.

U.S. Pat. No. 6,401,996 by Thom, et al. and issued on Jun. 11, 2002, is for an article-carrying attachment for walkers and the like. It discloses an article-carrying apparatus that is provided for attachment to a mobile walker having a frame including at least one generally horizontal frame member supported by one or more generally vertical depending legs.

U.S. Pat. No. 5,513,789 by Woods, et al. and issued on May 7, 1996, U.S. Pat. No. 5,511,710 by Woods, et al. and issued on Apr. 30, 1996, and U.S. Pat. No. 5,340,005 by Woods, et al. and issued on Aug. 23, 1994, are for fabric accessories for crutches and walkers, providing carrying expandable volumes for personal use items and shopping items, and presenting reflective fabric portions thereof for observation by others. It discloses reflective fabrics that are used extensively throughout strong, expandable, selectively and resiliently restrained fabric accessories for removable securement to crutches and walkers, to provide expandable carrying volumes for personal use items and shopping items, while at the same time presenting the reflective fabric portions to be readily observed, especially by operators of vehicles.

U.S. Pat. No. 5,392,802 by Farr, et al. and issued on Feb. 28, 1995, and U.S. Pat. No. 5,273,063 by Farr, et al. and issued on Dec. 28, 1993, are for a folding tray for invalid walkers. It discloses a fold-down detachable utility tray for invalid walkers, including a generally rectangular tray frame in combination with a pair of locking, fold-down arms each having spring clips for securement to the upright members of an invalid walker.

U.S. Pat. No. 5,012,963 by Rosenbaum and issued on May 7, 1991, is for a walker support tote bag. It discloses a walker support tote bag as adapted to be mounted to a walker support for carrying a variety of articles. The tote bag includes a large inner compartment within the tote bag for receiving a variety of articles and outer peripherally spaced pockets along an outer face of the tote bag for receiving articles, generally of smaller size. The outer peripherally spaced pockets have a different contrasting color than the tote bag to aid a user in positioning articles within the pockets. The tote bag and the outer peripherally spaced pockets are made from flexible material to enable the tote bag to be closed and collapsed for carrying and storage purposes. For mounting the tote bag to the walker support, strap elements are attached to the tote bag and are configured, arranged and dimensioned relative to the tote bag to cause the large inner compartment thereof to be continuously maintained in an open position for receipt of a variety of articles therein, as well as to enable the outer peripherally spaced pocket to also receive articles.

U.S. Pat. No. 4,974,760 by Miller and issued on Dec. 4, 1990, is for an article carrier for a walker. It discloses an article carrier attachable to a front brace of a walker and composed of a flexible material whereby the article carrier is foldable with the walker as the walker is collapsed for storage or transport.

U.S. Pat. No. 4,850,641 by Walker and issued on Jul. 25, 1989, is for a combination carrying pouch and seat for walkers. It discloses a combination carrying pouch and seat for walkers. The inventive device includes a substantially rectangular piece of material having one end which may be securely fastened to front portions of the walker and having another end which may be releasably attached to either rear portions of the walker or front portions thereof. When the other end of the walker is attached to rear portions of the walker, the material is in an open configuration and may be used as a seat. When the other end is attached to front portions of the walker, the material is in a folded configuration rendering it usable as a carrying pouch.

U.S. Pat. No. 4,800,911 by Endres, et al. and issued on Jan. 31, 1989, is for a walker carrier. It discloses an improved container comprising a frame and a flexible receptacle secured thereto that includes bracket or hook means for being secured substantially entirely within the space between opposite leg members in a walker.

U.S. Pat. No. 4,491,257 by Ingles and issued on Jan. 1, 1985, is for an attachable basket for invalid support equipment. It discloses an article carrying receptacle attachable to an item of invalid support equipment such as a wheelchair, crutch or walker. The invalid support equipment mounts a bracket at a position away from the usual working surfaces of the item. A basket has a hook mounted thereon which is operable to overlap and releasably engage the bracket to support the basket at the convenience of the user.

U.S. Pat. No. 4,452,484 by Pastor and issued on Jun. 5, 1984, is for a walker. It discloses an improved walker, wherein the improvement comprises: a) a tray having slidable supports removably mountable within brackets disposed on the rear legs of the walker, with said tray further having hooks engageable on a horizontal support rod of the walker for storage; b) a removably mountable seat whose two lateral edges each extend beyond and rest upon support rods, with said seat having lateral movement stops to prohibit seat movement during use, and with said seat further having hooks engageable on a horizontal support rod of the walker for mounting or for storage; and c) a back rest disposed behind and mounted to an upper support rod extending between the legs at the front of the walker.

U.S. Pat. No. 4,449,750 by Pultman and issued on May 22, 1984, is for accessories for wheelchairs and the like. It discloses container accessories that are configured for removable securement to mobility aids such as walkers, wheelchairs or the like with tubular frame members.

U.S. Pat. No. 4,184,618 by Jones and issued on Jan. 22, 1980, is for an article carrying attachment for walkers. It discloses a caddy for attaching to a walker having a compartment sub-divided to accommodate various items and suspended from two or more hangers or hooks, securable to a walker frame member.

U.S. Pat. No. 4,074,683 by Di Chiara and issued on Feb. 21, 1978, is for a walker with tray. It discloses a walker for infirm individuals with provision for supporting a cradle for a removable tray, and the tray at the front of the walker. The cradle may be arranged to swing to remain level at all times or may be rigidly secured to the walker.

U.S. Pat. No. 3,957,071 by Kenner and issued on May 18, 1976, is for a carrier attachment for invalid walkers. It discloses a carrier attachment including a rigid tray section and a pocket section is suspended by connecting straps from one side of the top frame member of an invalid walker. The tray section can be swung to operative position above and supported by the top frame member.

United States Patent Application 20040040589 by Ennals, et al. and published on Mar. 4, 2004, is for a tray for a walker. It discloses a multipurpose carrying tray includes a housing for containing items. The housing includes a top surface and a support base wherein the top surface has a depth.

United States Patent Application 20020079663 by Haligrimsson, et al. and published on Jun. 27, 2002, is for a walker with movable carry basket.

There is still room for improvement in the art.

### SUMMARY OF INVENTION

The current invention is a walker bag that is attached to a walker. The walker bag will attach to the walker with an attaching means like a hook and latch means such as Velcro. Zippers, snaps or buttons are not used so that the current invention is easier to use for those who may not have the dexterity to use those items. Different styles of bags will have different placements of Velcro each with very defined positions for the Velcro. These positions are over the top of the bar and along the side bars at the bottom of the bag. In the preferred embodiment there will be 6 pockets—3 on the face of the unit and 3 on the inside of the unit. These pockets will be elasticized so that they can easily enter the pocket while out using zippers, buttons or snaps.

The walker bags will be used to carry personal items and to eliminate accidents.

### BRIEF DESCRIPTION OF DRAWINGS

Without restricting the full scope of this invention, the preferred form of this invention is illustrated in the following drawings:

FIG. 1 displays a standard walker;

FIG. 2 shows a front view of the bag attached to the walker;

FIG. 3 displays a view of the attachment means attaching the bag to the walker;

FIG. 4 displays a view of the elasticity pocket;

FIG. 5 displays a side view of the bag attached to the walker; and

FIG. 6 displays a back view of the bag attached to the walker.

### DETAILED DESCRIPTION

The following description is demonstrative in nature and is not intended to limit the scope of the invention or its application of uses.

There are a number of significant design features and improvements incorporated within the invention.

The current invention is a walker bag 1 that is attached to a walker 10. The walker bag 1 will attach to the walker 10 with an attaching means 15 like a hook and latch means such as Velcro. Zippers, snaps or buttons are not used so that the current invention is easier to use for those who may not have the dexterity to use those items. Different styles of bags will have different placements of Velcro each with much defined positions for the Velcro. These positions are over the top of the bar 25 and along the side bars 20 and 21 at the bottom of the bag. In the preferred embodiment there will be 6 pockets 40, 3 on the face of the unit and 3 on the inside of the unit. These pockets will be elasticized so that they can easily enter the pocket without using zippers, buttons or snaps.

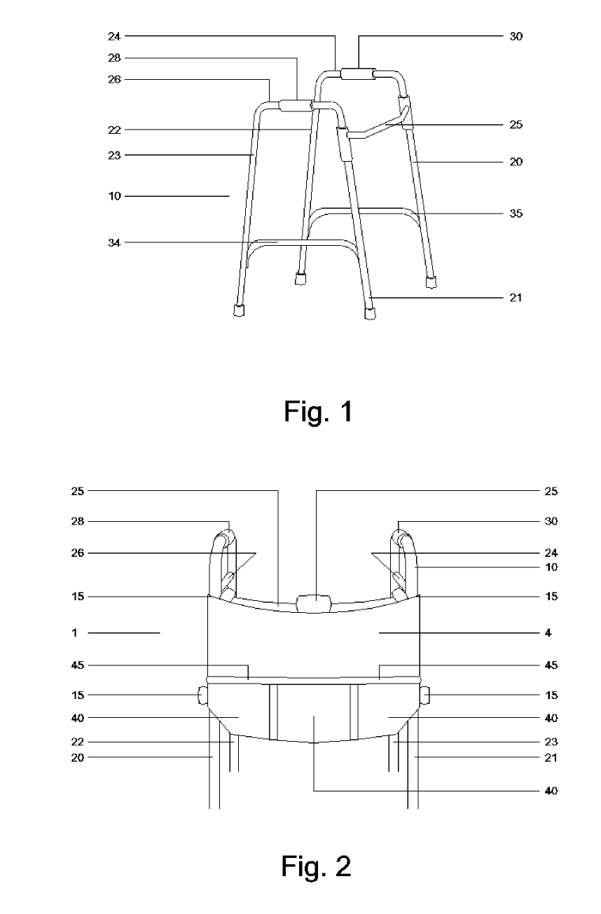

A standard walker 10 which by itself constitutes no part of the present invention is shown in FIG. 1. The standard walker 10 in this case has a pair of front legs 20 and 21, a pair of rear legs 22 and 23. The front legs and rear legs are connected together by at least the upper horizontal crossbars 24 (connecting the legs 20 and 22) and 26 (connecting together the legs 21 and 23). These horizontal crossbars are usually equipped with hand grips 28 and 29 respectively allowing a person utilizing the walker 10 to more easily hold onto the horizontal structures 26 and 24. Normally in order to strengthen the walker 10, the legs 20 and 22 are also interconnected by the horizontal bar 32 and the legs 21 and 23 are interconnected by the lower horizontal bar 34. The front legs 20 and 21 are interconnected by the crossbar 25.

The user of the walker 10 actually physically enters the walker 10 at the rear end as defined by the vertical legs 22 and 23, grasps the horizontal bars 24 and 26 usually utilizing the hand-hold elements 28 and 30. This allows the user to support himself or herself within the walker 10 with the walker legs being spaced and themselves maintained in the correct geometric formation essentially by the crossbar 25, the front and rear legs being spaced by the bars 24 and 32 and 26 and 34 respectively. In the usual walker device, some provision is made for collapsing the walker for easy storage.

FIG. 2 displays a front view of the bag 1. In the preferred embodiment that bag 1 would consist of a soft material such as a cloth. This type of material will be of a safe texture and surface to use while being durable and sturdy enough to store a user's items. It will also be easier to clean as it can be washed in a standard washing machine. The bag 1 can also collapse and fold in on itself when the walker 10 is collapsed.

The bag 1 will have a front 4 and back 6 sides.

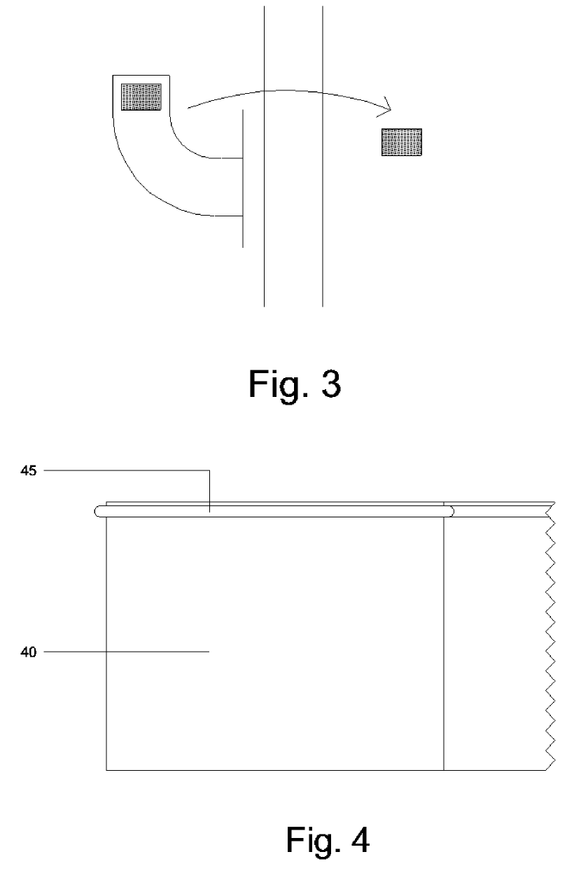

The bag 1 is rectangular in shape and covers the front of the walker 10. The bag 1 is attached to the walker 10 by attaching means 15 such as a hook and latch fasteners. The hook and latch fasteners are on tabs 16 which connect to connecting strips 17 on the back of the bag 1. This is shown in detail in FIG. 3. There will be a set of tabs 16 evenly spaced at the top of the bag 1 that will connect the bag 1 to the cross bar 25. In the preferred embodiment there will be one on the top left, one on the top right and one in the top center. There will also be a tab 16 that will attach the bag 1 to the left vertical leg 20 and one that will attach the bag 1 to the right vertical leg 21. These tabs 16 will secure the bag 1 to the walker 10.

The bag 1 will have a number of pockets 40 in the front of it on the front side 4. There are three pockets in the front in the preferred embodiment. The pockets 40 will be rectangular in shape and will have elastic bands 45 in the cuffs of the opening. These bands 45 will provide tension to close the pockets 40 but will allow a user with limited dexterity to access the pocket 40. This is displayed in FIG. 4.

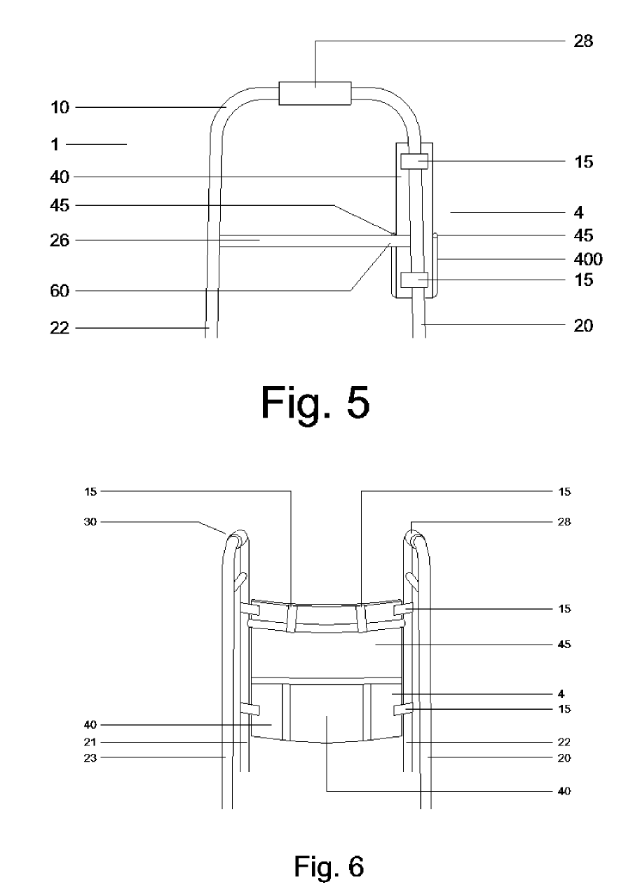

FIG. 5 displays a side view of the bag 1 as it is attached to the walker 10.

FIG. 6 displays a back view of the bag 1 as it is attached to the walker 10. It shows the tabs 16 connected to the strips 17. It also displays the three inside pockets 40 that are in the inside side back side 6 of the bag 1. These pockets 40 are rectangular in shape and positioned for easy access for the user since the user just has to reach straight down from the walker.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A bag adapted to be mounted to a walker, comprising:
front and back side each having a substantially rectangular configuration with a plurality of pockets on each side, having said bag attached to said walker through an attaching means.

2. The bag as defined in claim 1 wherein said bag is made of a cloth material.

3. The bag as defined in claim 1 wherein said attachment means consists of hook and latch fasteners.

4. The bag as defined in claim 1 wherein said bag is made of material that is machine washable.

5. The bag as defined in claim 1 wherein said bag is positioned on the front of said walker.

6. The bag as defined in claim 1 wherein said bag has tabs that are used to attached said bag to said walker.

7. The bag as defined in claim 6 wherein said tabs will be evenly spaced on the top of said bag.

8. The bag as defined in claim 6 wherein said bag has a plurality of tabs connecting said bag to the legs of said walker.

9. The bag as defined in claim 1 wherein said pockets will close by a tension means.

10. The bag as defined in claim 9 wherein said tension means are elastic bands.

11. The bag as defined in claim 10 wherein said elastic bans are in the cuffs of opening of said pockets.

12. The bag as defined in claim 1 wherein said pockets are positioned straight up and down for easy access.

13. The bag as defined in claim 1 wherein said bag is collapsible.

14. A bag adapted to be mounted to a walker, comprising:
front and back side each having a substantially rectangular configuration with a plurality of pockets on each side where said pockets will close by a tension means, having said bag attached to the front of said walker through an attaching means where said bag is made of a cloth material and wheresaid bag is collapsible.

15. The bag as defined in claim 14 wherein said attachment means consists of hook and latch fasteners.

16. The bag as defined in claim 14 wherein said bag has tabs that are used to attached said bag to said walker.

17. The bag as defined in claim 16 wherein said tabs will be evenly spaced on the top of said bag.

18. The bag as defined in claim 14 wherein said tension means are elastic bands.

19. The bag as defined in claim 18 wherein said elastic bans are in the cuffs of opening of said pockets.

20. The bag as defined in claim 14 wherein said pockets are positioned straight up and down for easy access.
